(19) United States
(12) Patent Application Publication
(10) Pub. No.: US 2010/0012796 A1
(43) Pub. Date: Jan. 21, 2010

(54) Mobile Cart Laptop Computer Retainer and Stand System

(76) Inventor: Alfred P. Rossini, Southborough, MA (US)

Correspondence Address: MIRICK, O'CONNELL, DEMALLIE & LOUGEE, LLP, 1700 WEST PARK DRIVE, WESTBOROUGH, MA, 01581, US

(21) Appl. No.: 12/552,594

(22) Filed: Sep. 2, 2009

Related U.S. Application Data
(63) Continuation-in-part of application No. 11/836,830, filed on Aug. 10, 2007, now Pat. No. 7,611,119.
Application No. 11/836,830 is a continuation of application No. 10/927,700, filed on Aug. 27, 2004, now abandoned.
(60) Provisional application No. 60/498,051, filed on Aug. 27, 2003.

(51) Int. Cl. F16M 11/04; E05B 73/00

(52) U.S. Cl. 248/176.1; 70/62

(57) ABSTRACT

A retainer and stand system for a laptop computer of the type having a keyboard portion and a display portion that is pivotally coupled to the keyboard portion, the retainer and stand adapted to be mounted to a mobile cart and releasably but securely retaining the laptop such that the display portion is visible to a user of the mobile cart. The retainer and stand has a five-sided receptacle defining a bottom portion, a front portion coupled to the bottom portion, a rear portion coupled to the bottom portion and spaced from the front portion, and spaced left and right side portions coupled to both the front and rear portions, the receptacle thereby defining an open-top cavity of sufficient size to hold at least most of the keyboard portion of the laptop within the cavity with the display portion projecting above the cavity, in which the receptacle is adapted to be mounted to a mobile cart to thereby make the laptop display visible to a user of the cart, and a cable coupled to the receptacle and adapted to be releasably coupled to the laptop, to secure the laptop to the receptacle.

### CROSS REFERENCE TO RELATED APPLICATIONS

This application is a continuation in part of copending application Ser. No. 11/836,830 filed on Aug. 10, 2007, which itself is a continuation of application Ser. No. 10/927,700 filed on Aug. 27, 2004 (now abandoned), which itself claimed priority of Provisional application Ser. No. 60/498,051, filed on Aug. 27, 2003. Priority of these applications is claimed. The disclosures of each of these prior applications are incorporated herein by reference.

### FIELD OF THE INVENTION

This invention relates to a retainer and stand system that supports and secures a laptop computer on a mobile cart.

### BACKGROUND OF THE INVENTION

Mobile carts used as workstations are known. These carts are commonly used in medical facilities and on manufacturing floors. They are typically adapted to carry a computer, and usually have additional shelf space available for the user, for such things as paper work, medications, and/or portable medical equipment.

These carts are typically used by many different people over the course of a day or a week. It is thus important that these carts have certain functional and ergonomic features. For example, for carts that are adapted for the use of a laptop computer, it is desirable for the laptop to be securely held in place yet accessible for viewing while held on the cart. It is typically also important for the display portion of the computer to be adjustable in both height and angle for optimal viewing. Further, it is imperative that there be some facility for locking the laptop while it is held in the use position, so that theft is deterred.

### SUMMARY OF THE INVENTION

One embodiment of the invention features a laptop computer retainer and stand system, for holding and retaining a laptop computer having a keyboard portion and a display portion that is pivotable relative to the keyboard portion, the retainer and stand comprising a base adapted to either sit on a surface or be coupled to a structure, and a support member coupled to the base, wherein the laptop keyboard portion sits on the support member, the support member comprising a retaining structure that overlies at least part of the laptop keyboard portion, to retain the keyboard portion on the support member. There is a locking mechanism coupled to the base or the support member, and selectively fixable to the laptop computer.

The embodiment may further include one or more of the following features. The support member may comprise a support plate on which the laptop keyboard portion sits. The support plate may be tilted at an angle from the horizontal. The support member may be tiltable relative to the base. The laptop computer stand may further comprise a lower support plate coupled to the support plate. The lower support plate may support the lower edge of the laptop keyboard portion. The lower support plate may be adjustably received in the support plate.

The retaining structure may overly the entire width of the laptop keyboard portion, or only the edges of the laptop keyboard portion. The locking mechanism may comprise separable parts. The parts may be receivable into one another to mechanically couple them together. The mechanical coupling may be accomplished with mating threads. The locking mechanism may further comprise brackets that releasably grip opposite sides of the laptop computer. The opposite sides may be of the display portion of the laptop computer. The locking mechanism may further comprise a padlock that is insertable through one of the separable parts. The padlock, when inserted, prevents the separation of the separable parts. The laptop computer stand may further comprise a cable that couples the locking mechanism to another part of the retainer and stand.

Featured in another embodiment of the invention is a retainer and stand system for holding and retaining a laptop computer of the type having a keyboard portion and a display portion that is pivotable relative to the keyboard portion, the retainer and stand comprising a base adapted to either sit on a surface or be coupled to a structure, a support member comprising a support plate coupled to the base, wherein the laptop keyboard portion sits on the support plate, the support member further comprising a retaining structure that overlies at least part of opposite edges of the laptop keyboard portion, to retain the keyboard portion on the support member. There is a locking mechanism coupled to the base or the support member, and selectively fixable to the laptop computer, the locking mechanism comprising two separable parts that can be mechanically coupled together and locked in the coupled position, each such part carrying a structure that releasably grips an edge of the laptop computer.

Featured in another embodiment is a retainer and stand system for a laptop computer of the type having a keyboard portion and a display portion that is pivotally coupled to the keyboard portion, the retainer and stand adapted to be mounted to a mobile cart and releasably but securely retaining the laptop such that the display portion is visible to a user of the mobile cart, the retainer and stand comprising a five-sided receptacle defining a bottom portion, a front portion coupled to the bottom portion, a rear portion coupled to the bottom portion and spaced from the front portion, and spaced left and right side portions coupled to both the front and rear portions, the receptacle thereby defining an open-top cavity of sufficient size to hold at least most of the keyboard portion of the laptop within the cavity with the display portion projecting above the cavity, in which the receptacle is adapted to be mounted to a mobile cart to thereby make the laptop display visible to a user of the cart and a cable coupled to the receptacle and adapted to be releasably coupled to the laptop, to secure the laptop to the receptacle. The open top of the cavity may be generally rectangular.

The side portions may extend outward from the front and rear portions and may be mainly open. Each side portion may comprise one or more elongated rod members that define generally “U” shapes where they extend furthest from the front and rear portions. The laptop computer retainer and stand may further comprise laptop retaining members movably mounted to rod members and constructed such that they can be slid along the rod members so as to lie up against the laptop keyboard portion, to help retain the laptop in the cavity.

The laptop computer retainer and stand may comprise a first rod that defines rod members of both sides of the receptacle. The rod may also extend upward from the top of the rear portion of the receptacle, to extend the height at which the laptop is supported by the receptacle. The laptop computer retainer and stand may further comprise a second rod that also defines rod members of both sides of the receptacle.

The cable may be coupled to the receptacle through a keyed lock or combination lock. The cable may be adapted to be releasably coupled to the laptop by a strap that is coupled to the cable and adapted to be releasably coupled to the laptop. The strap may define two “U”-shaped ends that are adapted to be coupled to the laptop.

The laptop computer retainer and stand may further comprise a cantilevered arm coupled to the rear portion of the receptacle above the cavity, the distal end of the arm adapted to be releasably coupled to the display portion of the laptop. The arm may comprise first and second relatively pivotable arm portions and a laptop support plate that defines the cantilevered end of the arm. The first arm portion may be pivotally mounted to the rear portion of the receptacle and the second arm portion may be pivotally mounted to both the first arm portion and the support plate. Each of the pivot joints may comprise a Belleville washer to provide holding force to the joints. The laptop support plate may be adapted to be releasably coupled to the display portion of the laptop by a two part loop and hook fastener system, one part on the support plate and one part on the display portion of the laptop.

### BRIEF DESCRIPTION OF THE DRAWINGS

Other objects, features and advantages will occur to those skilled in the art from the following description of the preferred embodiments and the accompanying drawings in which:

FIGS. 1A through 1C are perspective, exploded and rear views, respectively, of one embodiment of the laptop computer retainer and stand system of this invention;

FIGS. 2A and 2B are separated and assembled views, respectively, of a locking mechanism for the embodiment of FIGS. 1A-1C;

FIG. 3 shows the combination of the retainer and stand system of FIGS. 1A-1C and locking mechanism of FIGS. 2A and 2B to accomplish a locking retainer and stand system for the invention;

FIG. 4A is an exploded view and 4B a side view of an alternative embodiment of the invention;

FIG. 5A shows a laptop being inserted into the embodiment of FIGS. 4A and 4B;

FIG. 5B shows the top section of a mobile cart on which the retainer and stand system of the invention can be mounted;

FIGS. 5C and 5D are side views of the retainer and stand system of FIGS. 4A and 4B mounted on the section of the mobile cart shown in FIG. 5B;

FIG. 6A is an exploded perspective view of another embodiment of the retainer and stand system of the invention;

FIGS. 6B and 6C are perspective and rear views, respectively, of the assembled retainer and stand system of FIG. 6A;

FIG. 6D is a partial cross-sectional view taken along line A-A of FIG. 6B;

FIG. 7A is a side view of the retainer and stand system of FIG. 6 mounted to a mobile cart;

FIG. 7B is an enlarged partial view of the mounted retainer and stand system of FIG. 7A;

FIG. 8 is a view similar to that of FIG. 7B, but with a laptop computer located in the retainer and stand system;

FIG. 9A is an exploded view of another embodiment of the retainer and stand system of the invention; and

FIG. 9B is a side view of the retainer and stand system of FIG. 9A in use with a laptop computer.

### DESCRIPTION OF THE PREFERRED EMBODIMENTS

This invention comprises a retainer and stand system for laptop computers. The inventive retainer and stand system is designed to be mounted on a mobile cart. The inventive retainer and stand system removably but securely holds the laptop at a convenient height and angle for the user of the mobile cart.

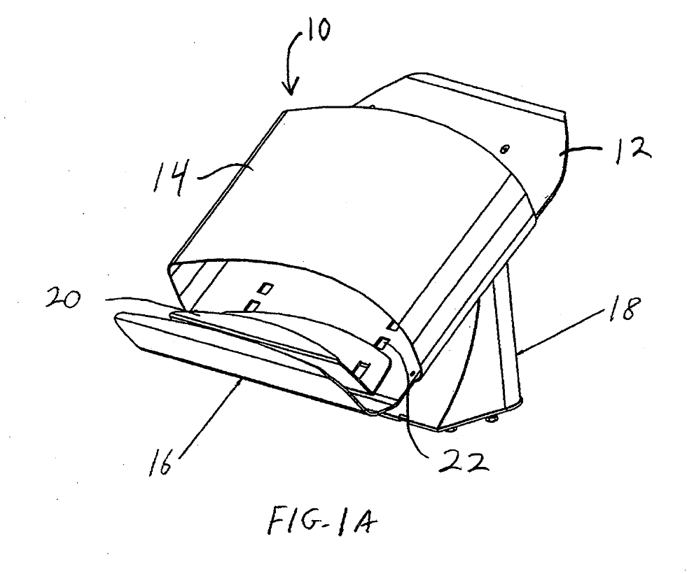

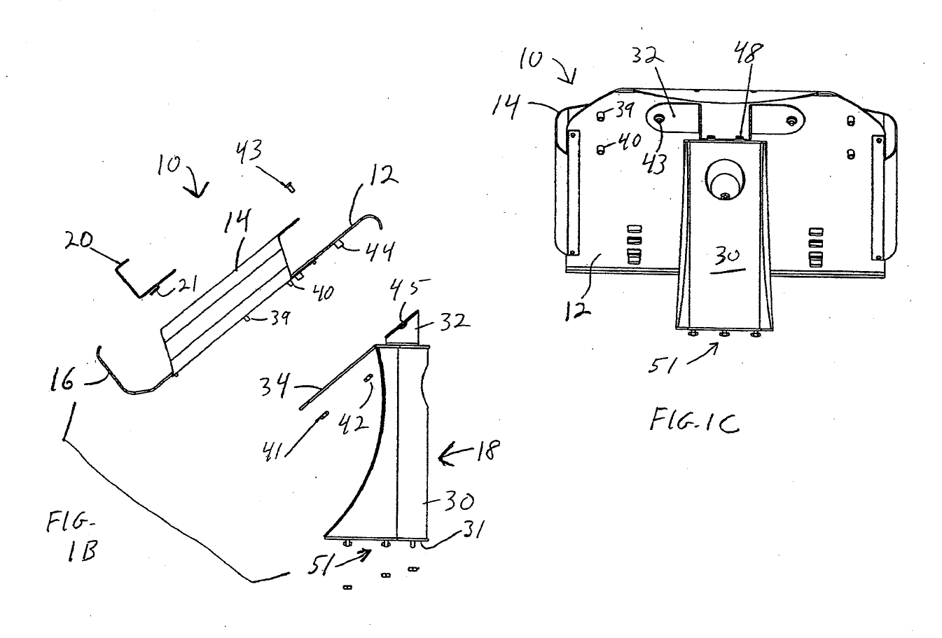

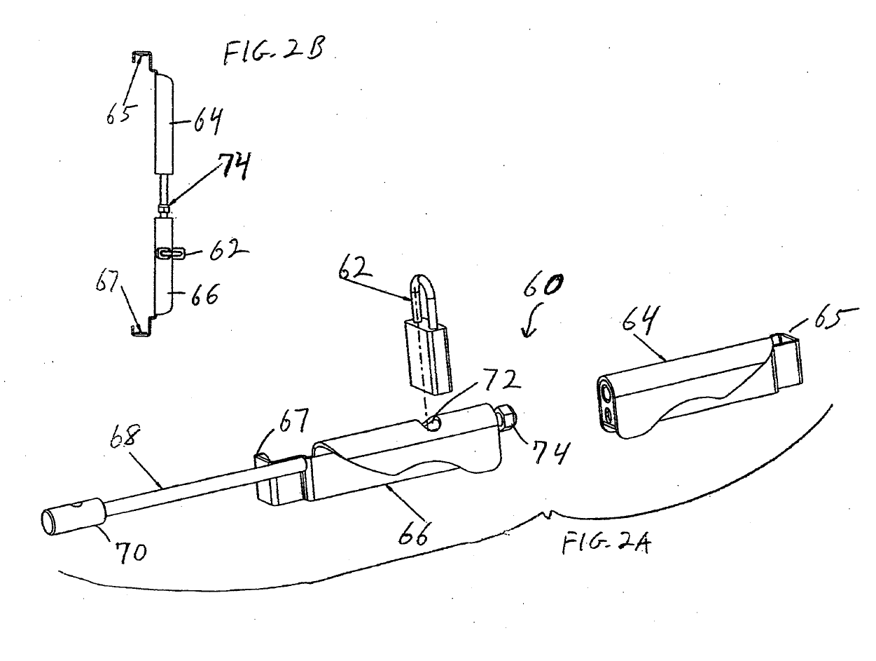

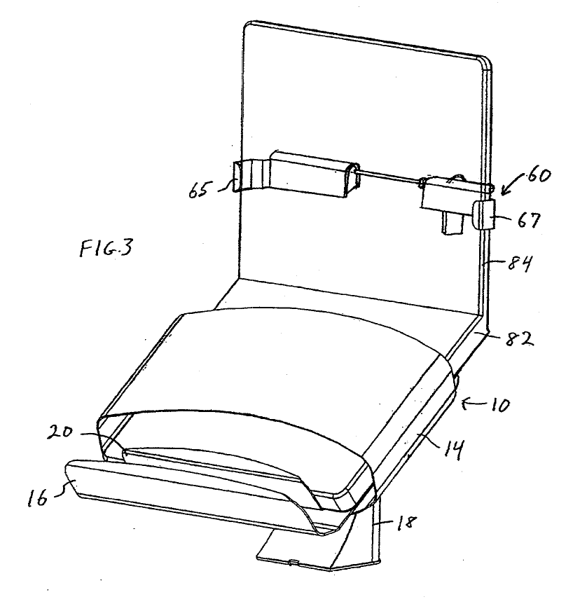

One embodiment of the invention is shown in FIGS. 1A-1C. An optional locking mechanism that prevents the laptop computer from being removed from the retainer and stand system is shown in FIGS. 2A and 2B. The combination of the retainer and stand system of FIGS. 1A-1C and the locking mechanism of FIGS. 2A and 2B to accomplish a locking retainer/stand system is shown in FIG. 3.

Retainer and stand system 10 comprises angled support member 12 that is held by base 18. Base 18 can be adapted to sit on a horizontal surface or be attached another structure, as further explained below. Overlying retainer member 14 along with member 12 creates a surround that defines an open top and open bottom cavity into which the keyboard portion of a laptop computer is placed. Lower support plate 16 provides an area or stop against which the lower (keyboard) portion of the laptop rests. Adjustable auxiliary plate 20, against which the bottom edge of the laptop rests, may optionally be included so that the device can accommodate different size laptops, or to provide additional adjustability. Plate 20 is adjustable to a number of positions relative to member 12 to move the bottom laptop support area up-and-down relative to member 14 as desired, using a slot 22 and insertable tab 21 arrangement.

Retainer and stand system 10 is shown in exploded view in FIG. 1B and rear view in FIG. 1C. Base 18 includes base member 30 with lower surface 31 that may be placed on a table, desk or the like. Alternatively, coupling studs and nuts assembly 51 may project from the bottom of surface 31 to allow the device to be bolted to a mobile cart, desk or the like.

Member 12 is coupled to member 30 through bracket 32 and fasteners 43 that pass through openings 44 and are received in nuts 45. Projecting studs such as studs 39 and 40 pass through cantilevered plate 34 and are held therein with nuts 41 and 42, respectively.

Locking mechanism 60 shown in FIGS. 2A and 2B comprises separable members 64 and 66 that can be mechanically coupled together and then prevented from separation by inserting lock 62 in opening 72. Threaded rod 68 with end member 70 passes through an opening in member 66 and threads into an insert that is fastened to member 64. End member 70 can be gripped and rotated, which causes member 64 to pull in toward member 66. This causes C-shaped end brackets 65 and 67 to overlap and releasably couple to opposite sides of the laptop display 84, as shown in FIG. 3. Once lock 62 is inserted, rod 68 cannot be rotated, so locking mechanism 60 cannot be removed from the laptop. A cable (not shown in this drawing) can be looped through openings in members 64 and 66 and through openings in another part of stand system 10 (not shown), with the cable ends crimped, to prevent removal of the locking mechanism from the laptop computer. As a result, mechanism 60 prevents the laptop from being removed from retainer and stand system 10. If retainer and stand system 10 is fixed to a larger structure, this increases the security of a laptop computer held in the inventive device.

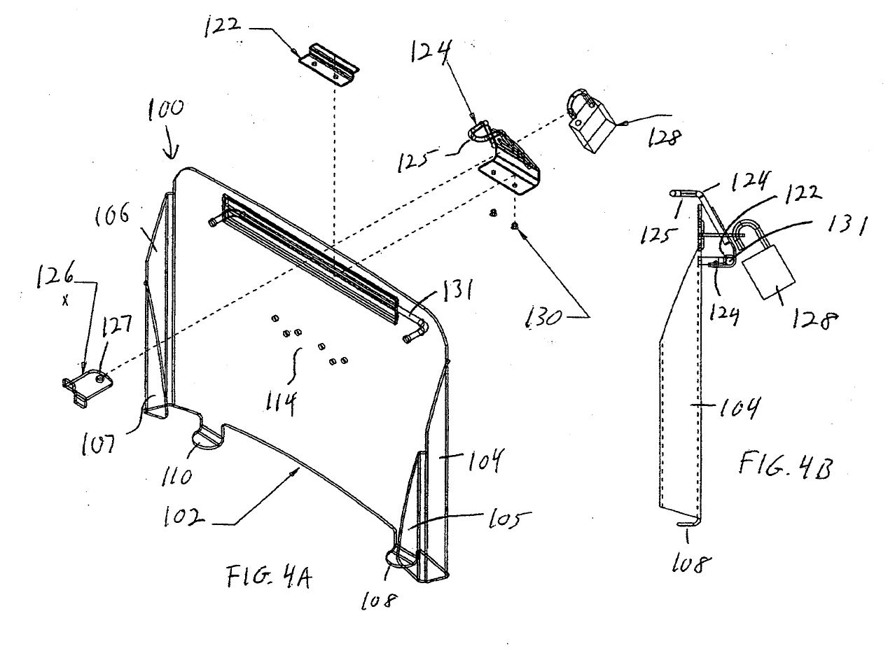

An alternative embodiment of the inventive retainer and stand system 100 is shown in FIGS. 4A and 4B. Retainer and stand system 100 has support member 102 with integral side members 104 and 106, having keyboard-overlaying portions 105 and 107, respectively. Portions 105 and 107 overly only a small portion of each side of the laptop keyboard portion. This allows the user to access the keys, mouse control functions, and other functional aspects located on the top side of the keyboard portion, so that the laptop can be used in a normal fashion while being supported by and retained by the inventive retainer and stand system. Lower integral tabs 108 and 110 support the lowermost edge of the laptop keyboard portion. Overlying upper tab 125 of sliding retaining member 124 lies against or very close to the top edge of the keyboard portion. This arrangement prevents the keyboard portion from being lifted off of member 102 when tab 125 is in place. As explained in more detail below, padlock 128 holds member 124 in place, which effectively locks the laptop in the retainer and stand system.

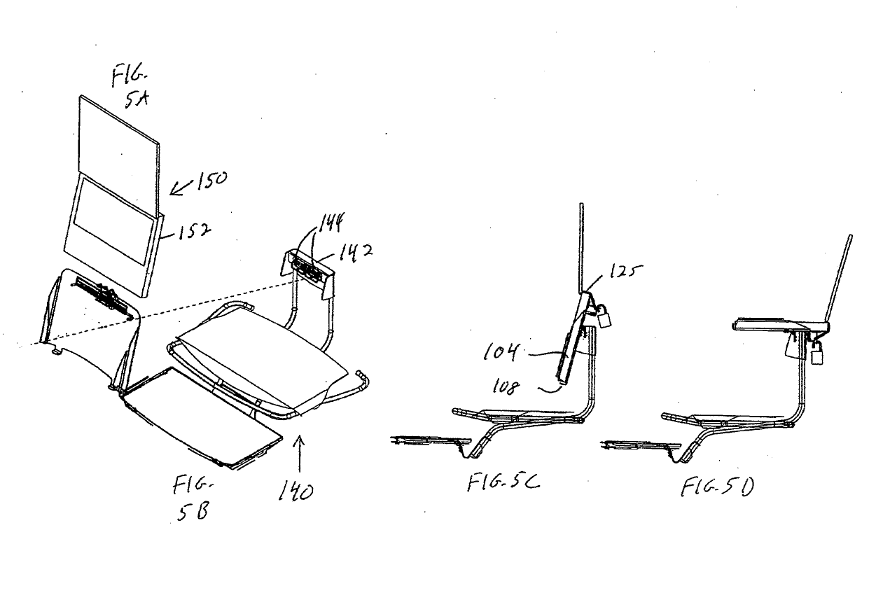

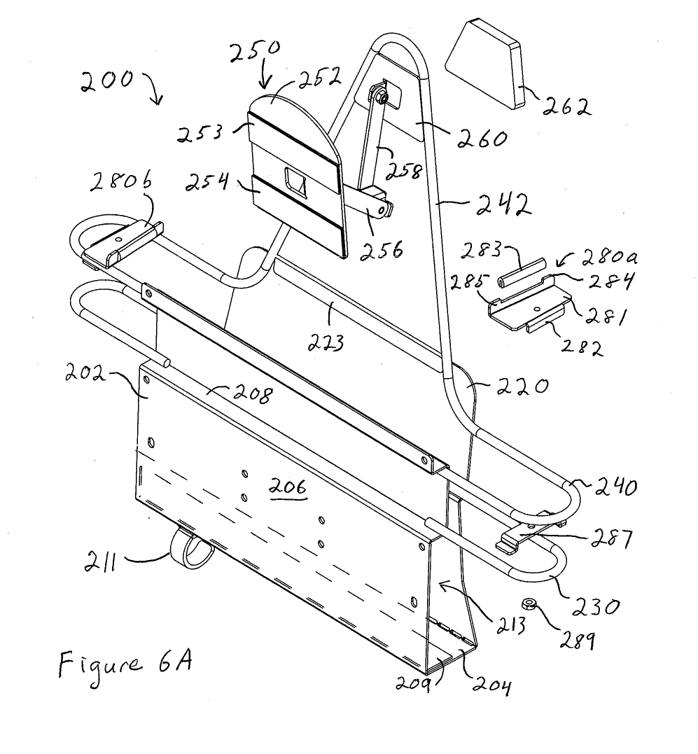

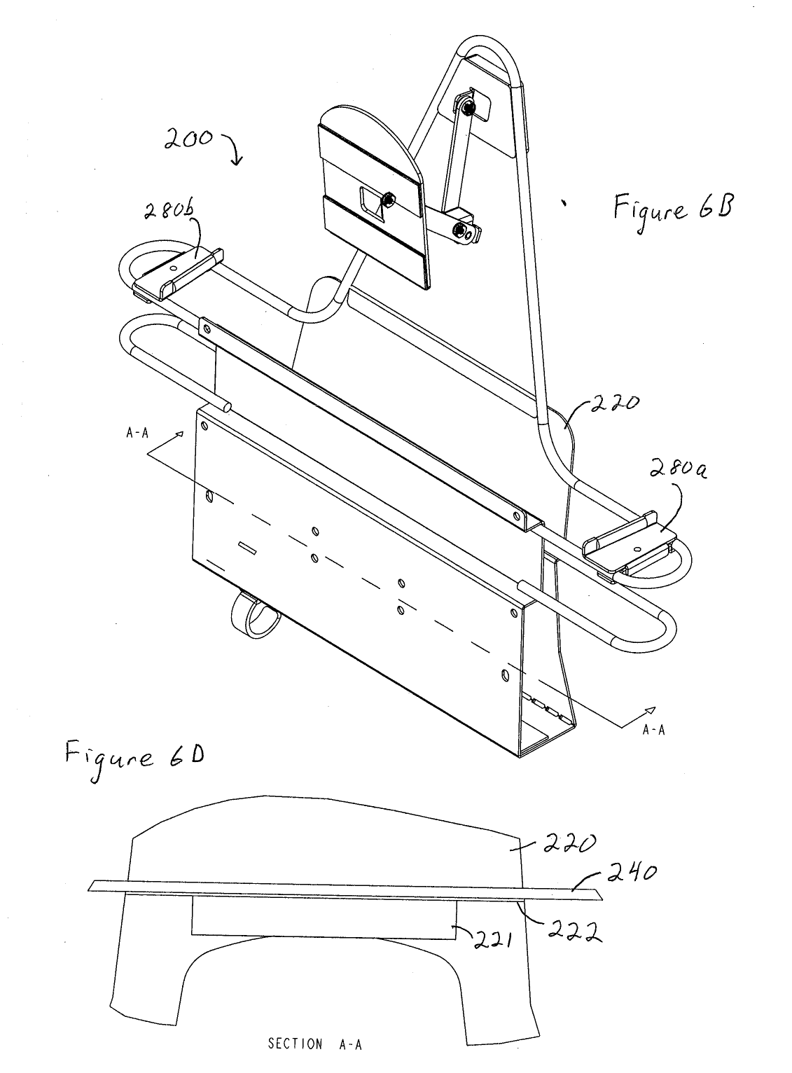

Member 122 is coupled to member 124 such that they mount on rear bar 131. This allows tab 125 to be slid left and right relative to the laptop. When the laptop is placed on the retainer and stand (as shown in FIG. 5A), tab 125 is slid to the side. It is then slid back in place to the middle. Tab 126 fits through member 124 such that opening 127 of tab 126 is accessible. Padlock 128 is then placed through opening 127, which effectively locks tab 125 in place over the end of the laptop keyboard portion 152. The laptop is now held by and secured by the retainer and stand system.

Retainer and stand system 100 can be constructed such that it is pivotable relative to the structure to which it is coupled. In the example shown in FIGS. 5B-5D, this structure is the top portion of a mobile laptop computer stand such as the Z cart available from JACO, Inc. of Franklin, Mass. Pivoting can be accomplished by using continuous torque hinges 144 on fixed member 142, that are coupled to the stand through openings 114 in support member 102. These hinges are preferably arranged such that the laptop is pivotable from an almost vertical position shown in FIG. 5C, to a horizontal position shown in FIG. 5D. This allows both the keyboard portion and the display portion of the laptop to be placed at a desired angle. The cart has inherent height adjustment, which thus accomplishes adjustability of the laptop in four degrees of freedom.

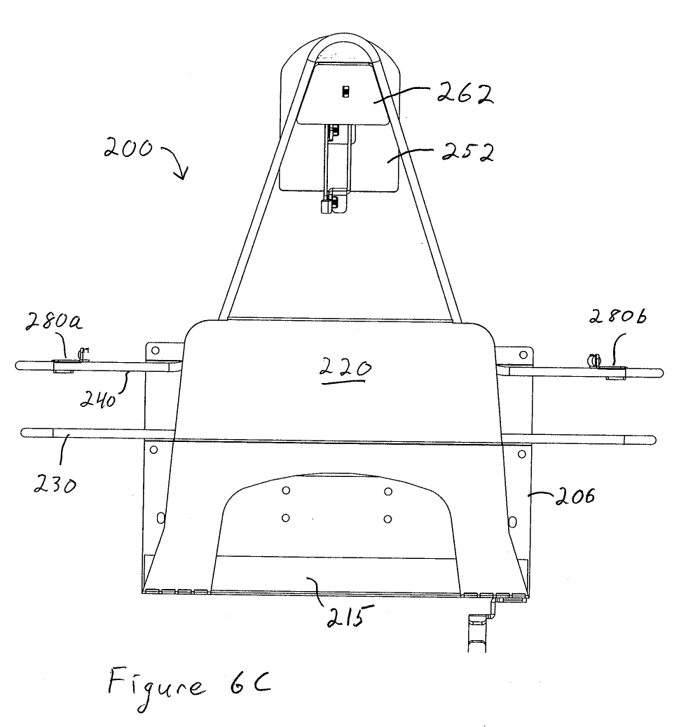

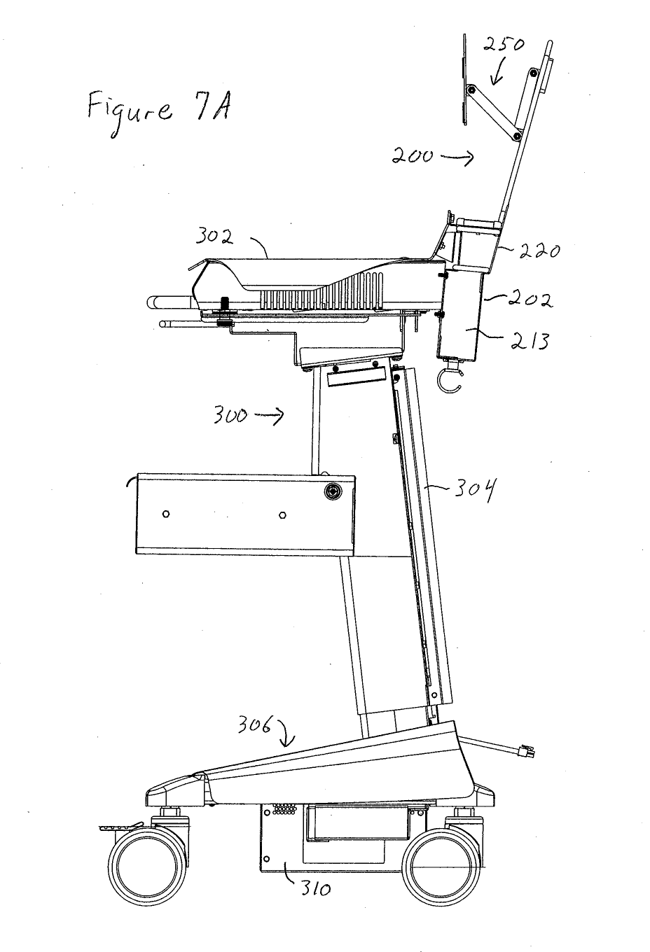

Another embodiment of the inventive retainer and stand system is shown in FIGS. 6A-8. Retainer and stand system 200 includes five sided receptacle 202. Receptacle 202 defines bottom elongated rectangular portion 204 with front portion 206 and rear portion 220 coupled to portion 204. These three portions can be formed of a single sheet metal element that is properly bent, or can be formed in another manner as would be apparent to one skilled in the art. Left and right side portions are coupled to both the front and rear portions. The side portions are accomplished with first and second bent rods 230 and 240 that are each coupled to the front and rear portions as shown in the drawings. In this particular embodiment, rod 230 sits on horizontal shelf 208 in front portion 206, and also sits on horizontal shelf 222 in rear portion 220. These shelves also help to accomplish a slight rearward-facing offset so that the cavity is generally angled from front to rear. The angled cavity holds the laptop in a more convenient orientation, as shown and described below. Second rod 240 can further be bent about its mid-length in a generally “A”-shape 242 so as to extend the height of the rear portion, to better support the laptop as explained below.

Laptop retaining members 280a and 280b are coupled to member 240 in a manner which allows them to be slid in and out relative to open top cavity 213. These retaining members are adapted to be slid up against the edges of the keyboard portion of the laptop computer to help retain the keyboard portion of the laptop in the cavity and prevent it from sliding or moving side-to-side or forward and backward, particularly as the cart is being moved. In this embodiment, these retaining members are formed with an upper portion 281 that has downwardly extending outwardly-facing stop 282 that prevents the member from being slid off the “U”-shaped ends of rod 240. Upwardly-extending spaced ears 284 and 285 define two support locations for rubber bumper 283. Bumper 283 itself defines a slot that fits over these ears. Member 281 is coupled to rod 240 with lower member 287 that sits below the rod and defines rod-receiving saddles. A bolt (not shown) and nut 289 hold members 281 and 287 together with rod 240 sandwiched between them. An assembled version 280b is shown on the left of FIG. 6A.

This embodiment also includes cantilevered arm 250 that is coupled to the rear portion of the receptacle above cavity 213. The distal end of arm 250 is adapted to be releaseably coupled to the display portion of the laptop. Arm 250 thus helps to hold the laptop display at a convenient angle for the user, and also acts as a shock absorber to help inhibit unwanted motions of the display portion of the laptop as the mobile cart is moved.

Arm 250 is coupled to upstanding portion 242 of rod 240 through base 260, the back of which is covered by rear decorative cover 262. First and second relatively pivotable arm portions 258 and 256 carry laptop support plate 252 that defines the cantilevered end of arm 250. Plate 252 is adapted to be releaseably coupled to the display portion of the laptop in a desired mechanical fashion. In this embodiment, this coupling is accomplished with one or more areas of a two part hook and loop mechanical fastener system such as available from the Velcro™ company. Fastener strips 253 and 254 on plate 254 can comprise the hook portion of the mechanical fastener system. One or more appropriately sized and shaped areas of the loop part of the fastener system (not shown) would then be adhered to the back of the laptop display portion, so that the two can be releaseably coupled together.

In the embodiment, there are several rubber strips placed to help cushion the locations at which the laptop is most likely to touch the receptacle. These help to prevent metal to metal contact that might scratch the laptop. Strip 209 is placed at the front of bottom portion 204 along the entire 11 inch length of portion 204. Strip 209 is about 1 inch wide. A second 1 inch wide strip 221 is placed just below horizontal shelf 222 in rear receptacle portion 220. A third shorter strip 223 is placed at the top of portion 220 inside of member 242. Fourth strip 215 is placed at the inside bottom of front portion 206. Clip 211 FIG. 6A is a power cord catch. The plug end of the on-cart power supply recharge power cord (not shown in the drawings) is retained in this easy access clip or holder.

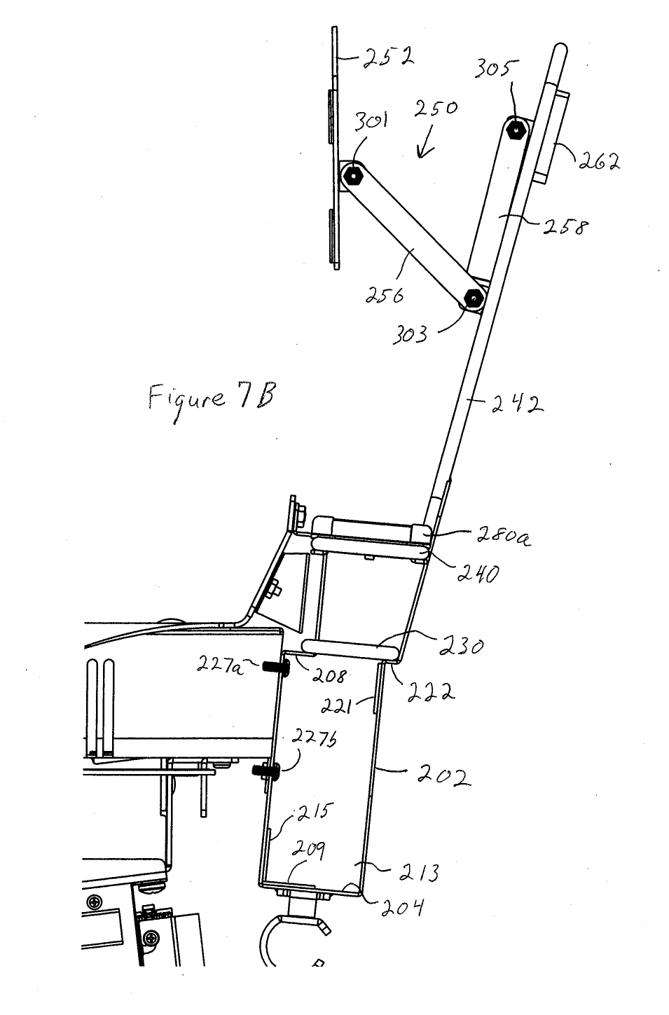

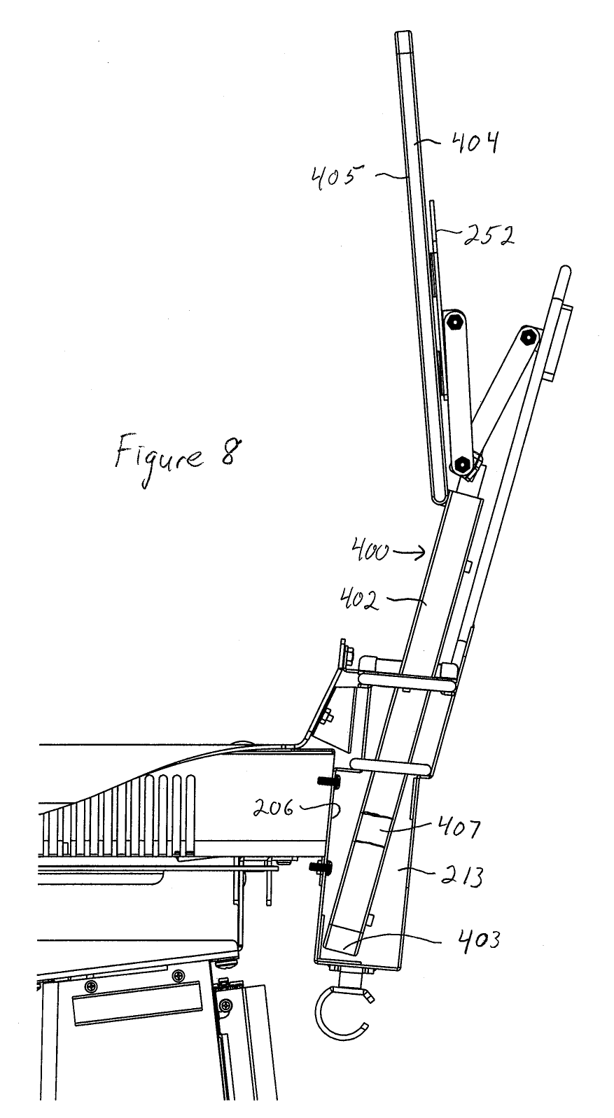

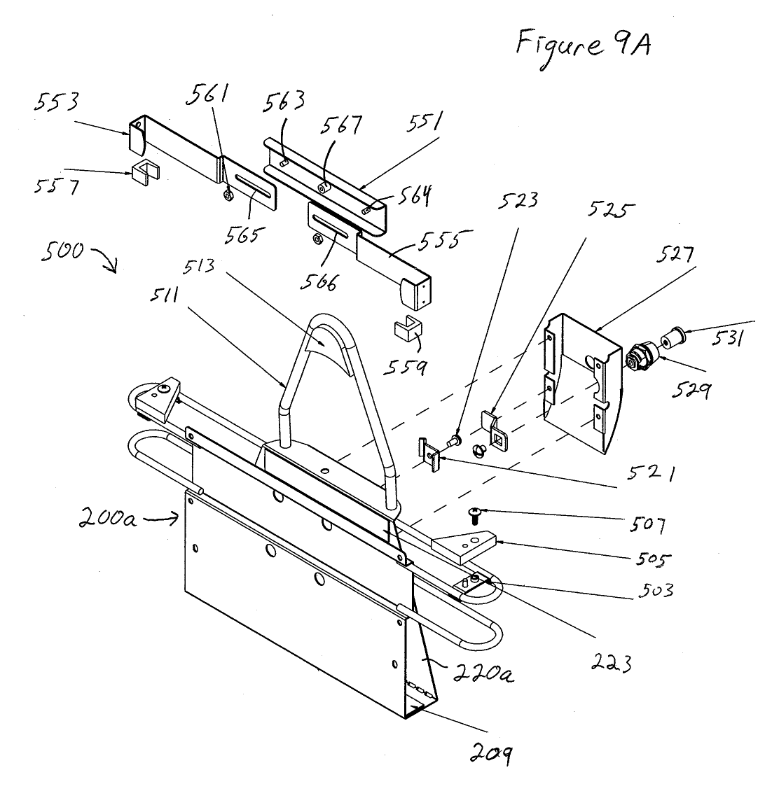

Retainer and stand system 200 is shown mounted to a mobile cart 300 in FIGS. 7A, 7B and 8. This is one of myriad types of rolling mobile carts to which the invented retainer and stand system can be adapted to be mounted, and shows one of myriad locations on the cart at which system 200 could be mounted. In this case, the mounting is accomplished with screws or bolts 227a and 227b passing through holes in front portion 206 of receptacle 202 (visible in FIG. 6A). Cart 300 includes upper section 302 that defines an upper horizontal surface, lower wheeled section 306 that carries battery retainer 310, and intermediate generally vertical section 304 that can include an adjustable-height post. Rolling carts 300 that are adapted to carry laptop computers and/or desktop computers and/or other equipment such as barcode scanners and the like are known in the art and are available from manufacturers such as JACO, Inc. of Franklin, Mass. (e.g., the JACO Ultralite™ cart).

As shown in the drawings, the slight rearward angle of portion 220 above horizontal shelf 222, with portion 242 of rod 240 following this angle, together with rearward facing horizontal shelves 208 and 222, create a rearward offset between the open generally rectangular top of cavity 213 and its closed bottom formed by bottom portion 204. The result is that when the keyboard portion 402 of laptop 400 is placed in cavity 213, with the front edge 403 resting against bottom 204 and proximate or against front 206, keyboard portion 402 tilts slightly backward. This allows display portion 404 (which pivots on keyboard portion 402) to maintain a vertical or close to vertical orientation. The orientation can be established by the user and maintained in place in part via arm 250 which helps to hold display portion 404 (which carries display 405 on one face) in place.

Arm 250 defines horizontal pivot axes at locations 301, 303 and 305. Axis 301 is located where arm portion 256 is coupled to support plate 252. Pivot axis 303 is located where arm portions 256 and 258 are coupled together. Pivot axis 305 is located where arm portion 258 is coupled to the rear portion of the receptacle via member 260. Each of these pivots can have a desired degree of stiffness so that they may maintain a desired position of display 405, but can be overcome with a reasonable amount of force applied by the user. This can be accomplished in a desired manner. Preferably, this is accomplished by using a bolt and a Belleville washer in combination; this provides holding force to the pivot joints. The two relatively pivotable portions that are each pivotally coupled at their ends allows a wide degree of latitude in the horizontal and vertical positioning of plate 252, as well as the angle of plate 252 relative to the vertical. This allows different sizes and types of laptop computers to be retained, as well as allowing the angle of the display portion of the laptop to be established as desired by the user with the location and angle retained by the arm.

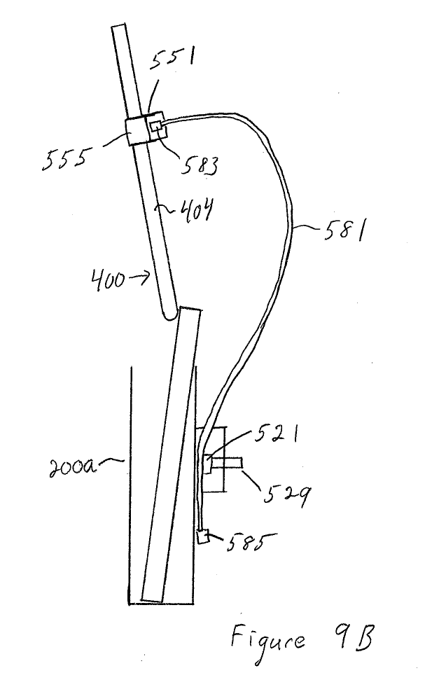

Embodiment 200 also includes a locking cable (not shown) that is preferably coupled to receptacle 202 and is adapted to be releaseably coupled to the laptop. This cable arrangement allows the laptop to be secured or locked to the receptacle to provide security for times when the user is not directly present. One cable arrangement is shown in FIG. 9B and described below. Another arrangement can use a standard Kensington lock feature 407, FIG. 8, that is present in most laptop computers. A standard commercially-available keyed or combination locking cable adapted to be used with a Kensington lock is coupled to the laptop's Kensington lock 407 and wrapped around a convenient location of the retainer and stand system 200, or even elsewhere on the mobile cart 300 as is convenient and desired by the user. Since the rods 230 and 240 provide a proximate and convenient point of attachment, such can be conveniently used with a relatively short Kensington laptop cable lock.

Another similar embodiment of the inventive retainer and stand system 500 is shown in FIGS. 9A and 9B. This embodiment differs primarily by the means by which the cable is coupled to the receptacle and releaseably coupled to the laptop. In brief, a short length of dedicated cable is coupled between a cable retainer that is operable via a keyed lock and a strap that is adapted to be releaseably coupled to the laptop.

Five sided receptacle 200a is almost identical to receptacle 200 and defines a cavity with a generally rectangular open top into which a laptop keyboard portion can be placed. Slightly different retaining members are shown in this embodiment, with a retainer member defining an angled soft bumper 505 that is coupled to sliding bumper support member 503 via screw 507 and a post and hole arrangement that prevents bumper 505 from rotating on screw 507. Receptacle 200a also displays a slightly different arrangement of the rods and the upstanding rear portion 511 with upper rubber bumper 513 that is designed to backstop the keyboard portion of the laptop in a relatively gentle manner.

Rear lock housing 527 is adapted to be coupled to rear portion 220a of receptacle 200a via screws or other fasteners. Housing 527 holds locking element 529 with lock core 531. Lock pawl 525 is coupled lock 529. Cable clamp 521 is held to rear portion 220a by screw 523. In this arrangement, one end of flexible cable 581 is held in place by the operation of lock 529 and cable clamp 521; when the lock is released, the cable can be slid through clamp 521, up to enlarged end 585. This allows the cable to be coupled to and removed from the laptop. The other end of cable 581 defines an enlarged end 583 that sits on the inside of opening 567 in strap 551. Horizontally adjustable (slidable) retaining straps 553 and 555 can be adjusted to a desired width via slots 565 and 566 that fit over threaded studs 563 and 564. Nuts such as nut 561 are used to hold the retaining straps in place on strap 551. Side support cushions 557 and 559 are held in the “U”-shaped ends of straps 553 and 555. This arrangement provides retaining strap ends that fit over opposite sides of the display portion 404 of laptop 400 as shown in FIG. 9B.

To use the device, the cable is released by unlocking lock 529, and the cable is slid to its farthest extent. This gives enough play to allow the strap construction to be slipped over the top of the keyboard portion of a laptop computer that has been placed in receptacle 200a. The strap is then slid down the display portion to a desired location, and the cable is pushed down through clamp 521 until it is relatively taut. Lock 529 is then operated to clamp cable 581 in place via cable clamp 521. The laptop vertical motion is then constrained by the effective length of the cable. This prevents the laptop from being removed from receptacle 200a until the lock is unlocked and the cable is loosened, which allows the strap to be slid off the top of the laptop display portion.

Although specific features of the invention are shown in some drawings and not others, this is for convenience only, as the features can be combined as would be apparent to those skilled in the art, and as the claims set forth the rights granted under the patent. Other combinations of features would be apparent to those skilled in the field and are within the scope of the claims.

What is claimed is:

1. A retainer and stand system for a laptop computer of the type having a keyboard portion and a display portion that is pivotally coupled to the keyboard portion, the retainer and stand adapted to be mounted to a mobile cart and releasably but securely retaining the laptop such that the display portion is visible to a user of the mobile cart, the retainer and stand comprising:
a five-sided receptacle defining a bottom portion, a front portion coupled to the bottom portion, a rear portion coupled to the bottom portion and spaced from the front portion, and spaced left and right side portions coupled to both the front and rear portions, the receptacle thereby defining an open-top cavity of sufficient size to hold at least most of the keyboard portion of the laptop within the cavity with the display portion projecting above the cavity, in which the receptacle is adapted to be mounted to a mobile cart to thereby make the laptop display visible to a user of the cart; and
a cable coupled to the receptacle and adapted to be releasably coupled to the laptop, to secure the laptop to the receptacle.

2. The retainer and stand system of claim 1 in which the side portions extend outward from the front and rear portions and are mainly open.

3. The retainer and stand system of claim 2 in which each side portion comprises one or more elongated rod members that define generally “U” shapes where they extend furthest from the front and rear portions.

4. The retainer and stand system of claim 3 further comprising laptop retaining members movably mounted to rod members and constructed such that they can be slid along the rod members so as to lie up against the laptop keyboard portion, to help retain the laptop in the cavity.

5. The retainer and stand system of claim 3 comprising a first rod that defines rod members of both sides of the receptacle.

6. The retainer and stand system of claim 5 in which the first rod also extends upward from the top of the rear portion of the receptacle, to extend the height at which the laptop is supported by the receptacle.

7. The retainer and stand system of claim 5 comprising a second rod that also defines rod members of both sides of the receptacle.

8. The retainer and stand system of claim 1 in which the cable is coupled to the receptacle through a keyed lock or combination lock.

9. The retainer and stand system of claim 1 in which the cable is adapted to be releasably coupled to the laptop by a strap that is coupled to the cable and adapted to be releasably coupled to the laptop.

10. The retainer and stand system of claim 9 in which the strap defines two “U”-shaped ends that are adapted to be coupled to the laptop.

11. The retainer and stand system of claim 1 further comprising a cantilevered arm coupled to the rear portion of the receptacle above the cavity, the distal end of the arm adapted to be releasably coupled to the display portion of the laptop.

12. The retainer and stand system of claim 11 in which the arm comprises first and second relatively pivotable arm portions and a laptop support plate that defines the cantilevered end of the arm.

13. The retainer and stand system of claim 12 in which the first arm portion is pivotally mounted to the rear portion of the receptacle and the second arm portion is pivotally mounted to both the first arm portion and the support plate.

14. The retainer and stand system of claim 13 in which each of the pivot joints comprises a Belleville washer to provide holding force to the joints.

15. The retainer and stand system of claim 13 in which the laptop support plate is adapted to be releasably coupled to the display portion of the laptop by a two part loop and hook fastener system, one part on the support plate and one part on the display portion of the laptop.

16. The retainer and stand system of claim 1 in which the open top of the cavity is generally rectangular.

17. A retainer and stand system for a laptop computer of the type having a keyboard portion and a display portion that is pivotally coupled to the keyboard portion, the retainer and stand adapted to be mounted to a mobile cart and releasably but securely retaining the laptop such that the display portion is visible to a user of the mobile cart, the retainer and stand comprising:
a five-sided receptacle defining a bottom portion, a front portion coupled to the bottom portion, a rear portion coupled to the bottom portion and spaced from the front portion, and spaced left and right side portions coupled to both the front and rear portions, the receptacle thereby defining a generally rectangular open-top cavity of sufficient size to hold at least most of the keyboard portion of the laptop within the cavity with the display portion projecting above the cavity, in which the receptacle is adapted to be mounted to a mobile cart to thereby make the laptop display visible to a user of the cart, in which the side portions extend outward from the front and rear portions and are mainly open, and in which each side portion comprises at least two elongated rod members that each define generally “U” shapes where they extend furthest from the front and rear portions, the receptacle comprising a first rod that defines rod members of both sides of the receptacle and a second rod that also defines rod members of both sides of the receptacle, in which the first rod also extends upward from the top of the rear portion of the receptacle, to extend the height at which the laptop is supported by the receptacle;
laptop retaining members movably mounted to rod members and constructed such that they can be slid along the rod members so as to lie up against the laptop keyboard portion, to help retain the laptop in the cavity;
a cantilevered arm coupled to the rear portion of the receptacle above the cavity, the distal end of the arm adapted to be releasably coupled to the display portion of the laptop, in which the arm comprises first and second relatively pivotable arm portions and a laptop support plate that defines the cantilevered end of the arm, in which the first arm portion is pivotally mounted to the rear portion of the receptacle and the second arm portion is pivotally mounted to both the first arm portion and the support plate; and
a cable coupled to the receptacle and adapted to be releasably coupled to the laptop, to secure the laptop to the receptacle.

18. A retainer and stand system for a laptop computer of the type having a keyboard portion and a display portion that is pivotally coupled to the keyboard portion, the retainer and stand adapted to be mounted to a mobile cart and releasably but securely retaining the laptop such that the display portion is visible to a user of the mobile cart, the retainer and stand comprising:
a five-sided receptacle defining a bottom portion, a front portion coupled to the bottom portion, a rear portion coupled to the bottom portion and spaced from the front portion, and spaced left and right side portions coupled to both the front and rear portions, the receptacle thereby defining a generally rectangular open-top cavity of sufficient size to hold at least most of the keyboard portion of the laptop within the cavity with the display portion projecting above the cavity, in which the receptacle is adapted to be mounted to a mobile cart to thereby make the laptop display visible to a user of the cart, in which the side portions extend outward from the front and rear portions and are mainly open, and in which each side portion comprises at least two elongated rod members that each define generally “U” shapes where they extend furthest from the front and rear portions, the receptacle comprising a first rod that defines rod members of both sides of the receptacle and a second rod that also defines rod members of both sides of the receptacle, in which the first rod also extends upward from the top of the rear portion of the receptacle, to extend the height at which the laptop is supported by the receptacle;
laptop retaining members movably mounted to rod members and constructed such that they can be slid along the rod members so as to lie up against the laptop keyboard portion, to help retain the laptop in the cavity; and
a cable coupled to the receptacle through a keyed lock or a combination lock and adapted to be releasably coupled to the laptop by a strap that is coupled to the cable and adapted to be releasably coupled to the laptop, the strap defining two “U”-shaped ends that are adapted to be coupled to the laptop, to secure the laptop to the receptacle.
